(19) United States
(12) Patent Application Publication
(10) Pub. No.: US 2020/0356415 A1
(43) Pub. Date: Nov. 12, 2020

(54) APPARATUS AND METHOD FOR DEPOYING A MACHINE LEARNING INFERENCE AS A SERVICE AT EDGE SYSTEMS

(71) Applicant: Nutanix, Inc., San Jose, CA (US)

(72) Inventor: Sandeep Reddy Goli, San Jose, CA (US)

(73) Assignee: Nutanix, Inc., San Jose, CA (US)

(21) Appl. No.: 16/522,567

(22) Filed: Jul. 25, 2019

Related U.S. Application Data
(60) Provisional application No. 62/844,638, filed on May 7, 2019.

(51) Int. Cl. G06F 9/50; G06N 20/00; G06N 5/04; H04L 29/08

(52) U.S. Cl. CPC G06F 9/5044; G06N 20/00; H04L 67/125; H04L 67/34; G06N 5/04

(57) ABSTRACT

An example edge system of an Internet of Things system may include a memory configured to store a machine learning (ML) model application having a ML model a machine, and a processor configured to cause a ML inference service to receive a request for an inference from a ML model application having a ML model, and load the ML model application from the memory into an inference engine in response to the request. The processor is further configured to cause the MT inference service to select a runtime environment from the ML model application to execute the ML model based on a hardware configuration of the edge system, and execute the ML model using the selected to provide inference results. The inference results are provided at an output, such as to a data plane or to be stored in the memory.

### CROSS REFERENCE TO RELATED APPLICATION(S)

This application claims priority to provisional application No. 62/844,638, filed May 7, 2019, which application is hereby incorporated by reference in its entirety for any purpose.

### BACKGROUND

Internet of Things (IoT) systems are increasing in popularity. Generally, IoT systems utilize a number of edge devices. Edge devices may generally refer to computing systems deployed about an environment (which may be a wide geographic area in some examples). The edge devices may include computers, servers, clusters, sensors, appliances, vehicles, communication devices, etc. Edge systems may obtain data (including sensor data, voice data, image data, and/or video data, etc.). While edge systems may provide some processing of the data at the edge device, in some examples edge systems may be connected to a centralized analytics system (e.g., in a cloud or other hosted environment). The centralized analytics system, which may itself be implemented by one or more computing systems, may further process data received from edge devices by processing data received by individual edge devices and/or by processing combinations of data received from multiple edge devices.

Machine learning (ML) models have become increasingly implemented as a tool to process data, but quite often consume significant computing resources. In IoT systems, deploying ML model applications to provide inferences to edge systems may impact performance of the edge systems due to consumption of computing resources. In some examples, edge systems may include hardware accelerators that can be leveraged to execute the ML model to provide an inference or prediction. However, in large IoT systems, deployed edge systems may have a wide array of different hardware capabilities and configurations. Thus, configuring a ML model to run efficiently on each given edge system may be increasingly complicated to specifically build and deploy ML model applications for each different hardware configuration type.

### BRIEF DESCRIPTION OF THE DRAWINGS

FIG. 1 is a block diagram of an Internet of Things system, in accordance with an embodiment of the present disclosure.

FIG. 2 is a block diagram of an edge computing system of an IoT system, in accordance with an embodiment of the present disclosure.

FIG. 3 is a block diagram of a distributed computing system, in accordance with an embodiment of the present disclosure.

FIG. 4 is a block diagram of a machine learning inference service and data, in accordance with an embodiment of the present disclosure.

FIG. 5 is a block diagram of an exemplary machine learning inference architecture, in accordance with an embodiment of the present disclosure.

FIG. 6 is a flow diagram of a method to generate and deploy a machine learning inference service, in accordance with an embodiment of the present disclosure.

FIG. 7 is a flow diagram of a method to execute a machine learning model at a machine learning inference service of an edge system, in accordance with an embodiment of the present disclosure.

FIG. 8 is a block diagram of components of an edge system or computing in accordance with an embodiment of the present disclosure.

### DETAILED DESCRIPTION

Examples described herein include building and deploying machine learning (ML) inferences as services at edge systems of an Internet of Things (IoT) system. A ML inference generation tool may configure a core ML (e.g., or artificial intelligence (AI), deep learning (DL), etc.) model inference for deployment to individual edge systems based on individual configurations of the edge systems. A core ML model may be loaded into the ML inference generation tool.

Based on the types of edge systems to which the core ML model is to be deployed, the ML inference generation tool configures a respective version of the ML model application to deploy to each different type of edge system to take advantage of specific edge system hardware capabilities. That is, in some examples, the ML inference generation tool may independently configure the ML model application for each edge system, including choosing respective runtime environment settings and memory usage, based on specialized hardware (e.g., graphics processor unit (GPU), tensor processing unit (TPU), hardware accelerators, video processing unit (VPU), Movidius, etc.) and other hardware configurations of the edge system. In other examples, the ML inference generation tool may configure the ML model application to allow each edge system to which the ML model application is deployed to choose an execution path that uses respective runtime environment settings and memory usage corresponding to specialized hardware and other hardware configurations of the respective edge system. Each ML model application may be formed in a respective “sandbox” and include a group of containers that communicate with each other via a virtual intra-“sandbox” network (e.g., a pod). Runtime information for the ML model may be determined based on heuristics and statistics collected for similar ML models, which can be estimated based on size. The edge system hardware information may be retrieved from a table or database of edge device hardware information.

The ML inference service hosted on an edge system may be configured to receive a request for a ML model, and to load the requested ML model in an inference engine. The inference engine may be configured to select a runtime based on a hardware configuration of the edge system, and execute the ML model to provide inference data. The inference data may be stored or provided at an output. In some examples, the inference engine may include one or more executors each configured to execute a particular ML model and version according to a respective runtime. The inference engine may be configured to optimize the ML model for execution based on a hardware configuration. The inference engine may communicate with a remote procedure call server to send and receive data associated with loading, executing, providing results, etc. associated with the ML model.

Various embodiments of the present disclosure will be explained below in detail with reference to the accompanying drawings. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

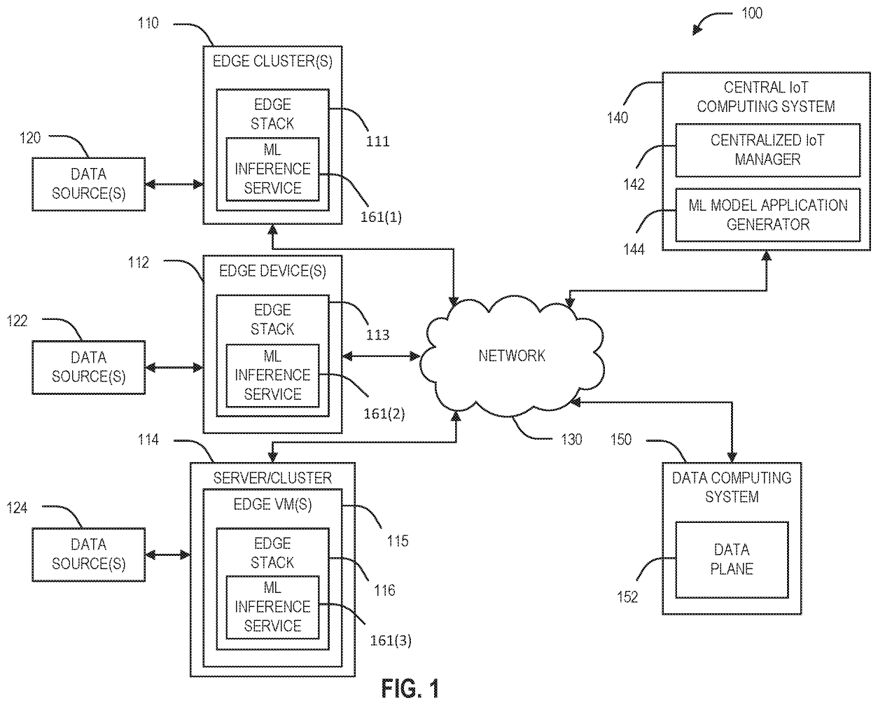

FIG. 1 is a block diagram of an Internet of Things (IoT) system 100, in accordance with an embodiment of the present disclosure. The IoT system 100 may include one or more of any of edge cluster(s) 110 coupled to respective data source(s) 120, edge device(s) 112 coupled to respective data source(s) 122, a server/cluster 114 coupled to respective data source(s) 124 and configured to host one or more edge virtual machines VM(s) 115. The IoT system 100 may further include a central IoT computing system 140 coupled to the one or more of the edge cluster(s) 110, the edge device(s) 112, and/or the edge VM(s) 115 hosted on the server/cluster 114 via a network 130 to manage configuration and operation of the IoT system 100. The IoT system 100 may further include a data computing system 150 coupled to the network 130 to configured to receive, store, process, etc., data received from the one or more of the edge cluster(s) 110, the edge device(s) 112, and/or the server/cluster 114 via a network 130.

The network 130 may include any type of network capable of routing data transmissions from one network device (e.g., the edge cluster(s) 110, the edge device(s) 112, the server/cluster 114, a computing node of the central IoT computing system 140, and/or a computing node of the data computing system 150) to another. For example, the network 130 may include a local area network (LAN), wide area network (WAN), intranet, or a combination thereof. The network 130 may include a wired network, a wireless network, or a combination thereof.

The IoT system 100 may include one or more types of edge systems selected from any combination of the edge cluster(s) 110, the edge device(s) 112, and/or the edge VM(s) 115 hosted on the server/cluster 114. Each of the edge cluster(s) (e.g., or tenants) 110 may include a respective cluster of edge nodes or devices that are configured to host a respective edge stack 111. The edge stack 111 may be distributed across multiple edge nodes, devices, or VMs of a respective one of the edge cluster(s) 110, in some examples. Each of the edge device(s) 112 may be configured to host a respective edge stack 113. Each of the edge VM(s) 115 may be configured to host a respective edge stack 116. In some examples, the server/cluster 114 may be included as part of the central IoT computing system 140 or the data computing system 150. For clarity, “edge system” may refer to any of the edge cluster(s) 110, the edge device(s) 112, and/or the edge VM(s) 115 hosted on the server/cluster 114. The edge stacks (e.g., any of the edge stack 111, the edge stack 113, and/or the edge stack 116) may include software configured to operate the respective edge system in communication between one or more of the respective data sources (e.g., the data source(s) 120, the data source(s) 122, and/or the data source(s) 124). The software may include instructions that are stored on a computer readable medium (e.g., memory, disks, etc.) that are executable by one or more processor units (e.g., central processor units (CPUs), graphic processor units (GPUs), tensor processing units (TPUs), hardware accelerators, video processing units (VPUs), etc.) to perform functions, methods, etc., described herein.

The data source(s) 120, the data source(s) 122, and the data source(s) 124 (“data sources”) may each include one or more devices configured to receive and/or generate respective source data. The data sources may include sensors (e.g., electrical, temperature, matter flow, movement, position, biometric data, or any other type of sensor), cameras, transducers, any type of RF receiver, or any other type of device configured to receive and/or generate source data.

Each of the edge stacks may include one or more data pipelines and/or applications. In some examples, some data pipelines and/or applications may be configured to receive and process/transform source data from one or more of the data sources, other data pipelines, or combinations thereof. In some examples, a data pipeline may span across multiple edge systems. Each of the one or more data pipelines and/or applications may be configured to process respective received data based on respective algorithms or functions to provide transformed data. The data pipelines can be constructed using computing primitives and building blocks, such as VMs, containers, processes, or any combination thereof. In some examples, the data pipelines may be constructed using a group of containers (e.g., a pod) that each perform various functions within the data pipeline (e.g., subscriber, data processor, publisher, connectors that transform data for consumption by another container within the application or pod, etc.) to consume, transform, and produce messages or data. In some examples, the definition of stages of a constructed data pipeline application may be described using a user interface or REST API, with data ingestion and movement handled by connector components built into the data pipeline. Thus, data may be passed between containers of a data pipeline using API calls.

In some examples, the edge stacks may further include respective ML inference services 161(1)-(3) that are configured to load and execute respective ML model applications. Thus, the ML inference services 161(1)-(3) hosted on a respective edge system may be configured to receive a request for an inference or prediction using a MIL model, and to load a ML model application that includes the requested ML model into an inference engine. The inference engine may be configured to select a runtime based on a hardware configuration of the edge system, and execute the ML model on input data to provide inference or prediction data. The inference data may be stored or provided at an output. In some examples, the inference engine may include multiple executors each configured to execute the ML model according to a different runtime. The inference engine may be configured to optimize the ML model for execution based on a hardware configuration. The inference engine may communicate with a remote procedure call server to send and receive data associated with loading, executing, providing results, etc. associated with the ML model. A respective inference master of each of the ML inference services 161(1)-(3) may be configured to manage inference engines at a respective edge system, including starting inference engines, stopping inference engines, allocation of hardware resources to each inference engines (e.g., processor usage and memory, and in an edge cluster, which computing node is assigned the inference engine), assigning user/client requests to a particular inference engine, or any combination thereof.

In some examples, the edge systems may cause transformed data from a data pipeline or an application, and/or inference data from an inference engine of the ML inference services 161(1)-(3) to be provided to a respective data plane as edge data, such as the data plane 152 of the data computing system 150, using respective data plane communication interfaces, including application programming interfaces (APIs). The data computing system 150 may be a dedicated computing system, or may include a centralized analytics system hosted on a network of remote servers that are configured to store, manage, and process data (e.g., cloud computing system).

The one or more data pipelines or applications of the edge stacks may be implemented using a containerized architecture that is managed via a container orchestrator. The data pipelines and/or applications communicate using application programming interface (API) calls, in some examples. In some examples, the ML inference services 161(1)-(3) may also be implemented in the containerized architecture. In other examples, the ML inference services 161(1)-(3) may be services integrated with an operating system of the respective edge stack.

The centralized IoT manager 142 hosted on the central IoT computing system 140 may be configured to centrally manage configuration of each of the edge systems and data sources via a central control plane. The central IoT computing system 140 may include one or more computing nodes configured to host the centralized IoT manager 142. In some examples, the centralized IoT manager 142 may be distributed across a cluster of computing nodes of the central IoT computing system 140.

In some examples, the centralized IoT manager 142 may be configured to manage, for each of the edge systems, network configuration and security protocols, installed software (e.g., including data pipelines and applications), connected data source(s) (e.g., including type, category, identifiers, data communication protocols, etc.), connected data plane(s), communication between the edge systems and users, etc. The centralized IoT manager 142 may maintain configuration information for each of the edge systems, data sources, associated users, including hardware configuration information, installed software version information, connected data source information (e.g., including type, category, identifier, etc.), associated data planes, current operational status, authentication credentials and/or keys, etc.

The centralized IoT manager 142 may be configured to generate (e.g., build, construct, update, etc.) and distribute data pipelines and applications to selected edge systems based on the configuration maintained for each edge system. In some examples, the centralized IoT manager 142 may facilitate creation of one or more project constructs and may facilitate association of a respective one or more edge systems with a particular project construct (e.g., in response to user input and/or in response to criteria or metadata of the particular project). Each edge systems may be associated with no project constructs, one project construct, or more than one project construct. A project construct may be associated with any number of edge systems. When a data pipeline is created, the centralized IoT manager 142 may assign the data pipeline to or associate the data pipeline with a respective one or more project constructs. In response to the assignment to or association with the respective one or more project constructs, the centralized IoT manager 142 may deploy the data pipeline to each edge system associated with the respective one or more project constructs.

For example, in response to a request for a new data pipeline associated with a particular type or category of data sources and/or a project construct, the centralized IoT manager 142 may identify data sources having the particular type or category (e.g., or attribute), and/or may identify respective edge systems are connected to the identified data sources of the particular type or category and/or are associated with the particular project construct. For each identified edge system, the centralized IoT manager 142 may generate a respective version of the application or data pipeline based on respective hardware configuration information for the edge system. That is, the centralized IoT manager 142 may independently generate the applications and data. pipelines to efficiently operate according to the specific hardware configuration of each edge system.

A ML model application generator 144 of the central IoT computing system 140 may receive and configure a core ML model as a ML model application for deployment to individual edge systems based on individual configurations of the edge systems. In some examples, each ML model application may be assigned to one or more project constructs, and may be deployed to edge systems based on associations with the one or more project constructs. That is, a core ML model may be loaded into the ML model application generator 144, and based on the types of edge systems to which the core ML model is to be deployed, the ML model application generator 144 configures a respective version of the ML model application to deploy to each different type of edge system to take advantage of specific edge system hardware capabilities. The independent generation of each ML model application by the ML model application generator 144, may include choosing respective runtime environment settings and memory usage based on specialized hardware (e.g., GPU, TPU, hardware accelerators, VPU, Movidius, etc.) and other hardware configurations of the edge system. Runtime information for the ML model may be determined based on heuristics and statistics collected for similar ML models, which can be estimated based on size. The edge system hardware information may be retrieved from a table or database of edge device hardware information.

Edge data and/or ML inference data may be provided from the edge systems to one or more respective data planes, such as the data plane 152 of the data cloud computing system 150, users, or other edge systems via the network 130. In some examples, the edge data may include some or all of the source data from one or more of the data sources, processed source data, data derived from the source data, combined source data, or any combination thereof. In some examples, the edge data may include and/or may be based on ML inference data. The data plane 152 may be configured to store the edge data, process the edge data, provide access to the edge data to clients, etc. The data computing system 150 may include one or more cloud platforms that includes a plurality of computing nodes configured to host one or more versions of the data plane 152.

In operation, the IoT system 100 may include any number and combination of data sources selected from the data source(s) 120, the data source(s) 122, and the data source(s) 124 that are ach configured to provide respective source data. The data sources of the IoT system 100 may collectively span any type of geographic area (e.g., across continents, countries, states, cities, counties, facilities, buildings, floors, rooms, systems, units, or any combination thereof). The number of data sources may range in the tens, hundreds, thousands, or more. The data sources may include sensors (e.g., electrical, temperature, matter flow, movement, position, biometric data, or any other type of sensor), cameras, transducers, any type of RF receiver, or any other type of device configured to receive and/or generate source data.

Rather than each of the data sources independently sending all source data directly to a data plane or user, the IoT system 100 may include any number and combination of edge systems selected from any combination of the edge cluster(s) 110, the edge device(s) 112, and/or the edge VM(s) 115 hosted on the server/cluster 114 that are proximately located with and connected to respective data sources and are each configured to receive and select/process/transform the source data that is provided to the data plane or user. The edge systems within the IoT system 100 may include homogenous hardware and software architectures, in some examples. In other examples, the edge systems have a wide array of hardware and software architectures and capabilities. Each of the edge systems may be connected to a respective subset of data sources, and may host respective data pipelines and applications (e.g., included in the edge stacks, such as the edge stack 111, edge stack 113, or edge stack 116) that are configured to process source data from a respective one or more of the connected data sources and/or transformed data from other applications and/or data pipelines.

Each of the one or more data pipelines and/or applications may be configured to process and/or distribute respective transformed data based on received source data (e.g., or other edge data) using respective algorithms or functions. In some examples, the algorithms or functions may include any other user-specified or defined function to process/transform/select/etc. received data. In some examples, an edge system may provide the transformed data from a data pipeline or an application of the one or more data pipelines or applications of the edge stacks to a respective destination data plane, such as the data plane 152 of the data computing system 150 as edge data. In some examples, the edge systems may be configured to share edge data with other edge systems. The one or more data pipelines or applications of the edge stacks may be implemented using a containerized architecture that is managed via a container orchestrator. The data pipelines and/or applications communicate using application programming interface (API) calls, in some examples.

The respective ML inference services 161(1)-(3) may work in conjunction with the data pipelines and applications to assist with processing data, in some examples. In some examples, the respective ML inference services 161(1)-(3) may process data independent of the data pipelines and applications. The ML inference services 161(1)-(3) may be configured to receive a request for an inference or prediction using a ML model, and to load a ML model application that includes the requested ML model into an inference engine in response to the request.

The inference engine may be configured to select a runtime based on a hardware configuration of the edge system, and execute the ML model on input data to provide inference or prediction data. The inference data may be stored or provided at an output, such as to a data plane or to a data pipeline or application. In some examples, the inference engine may include multiple executors each configured to execute the ML model according to a different runtime. The inference engine may be configured to optimize the ML model for execution based on a hardware configuration, and in some examples, may track and store statistics associated with execution of the ML model on a data set(e.g., processor usage, time, memory usage, etc.).

The inference engine may communicate with a remote procedure call server to send and receive data associated with loading, executing, providing results, etc. associated with the ML model. A respective inference master of each of the ML inference services 161(1)-(3) may be configured to manage inference engines at a respective edge system, including starting inference engines, stopping inference engines, allocation of a particular ML model application to an inference engine, allocation of hardware resources to each inference engines (e.g., processor usage and memory, and in an edge cluster, which computing node is assigned the inference engine), assigning user/client requests to a particular inference engine, or any combination thereof.

In some examples, the edge systems may cause transformed data from a data pipeline or an application, and/or inference data from an inference engine of the ML inference services 161(1)-(3) to be provided to a respective data plane as edge data, such as the data plane 152 of the data computing system 150, using respective data plane communication interfaces, including application programming interfaces (APIs). The data computing system 150 may be a dedicated computing system, or may include a centralized analytics system hosted on a network of remote servers that are configured to store, manage, and process data (e.g., cloud computing system). The centralized IoT manager 142 hosted on the central IoT computing system 140 may be configured to centrally manage configuration of each of the edge systems and data sources. In some examples, the centralized IoT manager 142 may be configured to manage, for each of the edge systems, data sources, and/or users, network configuration and security protocols, installed software (e.g., including data pipelines and applications), connected data source(s) (e.g., including type, category, identifiers, data communication protocols, etc.), connected data. plane(s), etc. The centralized IoT manager 142 may maintain configuration information for each of the edge systems, data sources, associated users, including hardware configuration information, installed software version information, connected data source information including type, category, identifier, etc. associated data planes, current operational status, authentication credentials and/or keys, etc.

The centralized IoT manager 142 may be configured to generate or update and distribute data pipelines and applications to selected edge systems based on the configuration maintained for each edge system. For example, in response to a request for a new data pipeline or application associated with a particular type or category of data sources, the centralized IoT manager 142 may identify data sources having the particular type or category, and identify respective edge systems are connected to the identified data sources of the particular type or category. For each identified edge system, the centralized IoT manager 142 may generate a respective version of the application or data pipeline based on respective hardware configuration information for the edge system. That is, the centralized IoT manager 142 may independently generate the applications and data pipelines to efficiently operate according to the specific hardware configuration of each edge system. The data pipelines may be constructed using a group of containers (e.g., a pod) each configured to perform various functions within the data pipeline (e.g., subscriber, data processor, publisher, connectors that transform data for consumption by another container within the application or pod, etc.). In some examples, the centralized IoT manager 142 may be configured to define stages of a constructed data pipeline application using a user interface or representational state transfer (REST) API, with data ingestion and movement handled by the connector components built into the data pipeline.

The ML model application generator 144 may receive and configure a core ML model as a ML model application for deployment to individual edge systems based on individual configurations of the edge systems. In some examples, the request to configure the core ML model as a ML mode inference may be received from the centralized IoT manager 142. In other examples, the request may be received directly from a user. In response to the request, a core ML model may be loaded into the ML model application generator 144, and based on the types of edge systems to which the core ML model is to be deployed, the ML model application generator 144 configures a respective version of the ML model application to deploy to each different type of edge system to take advantage of specific edge system hardware capabilities. The independent generation of each ML model application by the ML model application generator 144, may include choosing respective runtime environment settings and memory usage based on specialized hardware (e.g., GPU, TPU, hardware accelerators, VPU, Movidius, etc.) and other hardware configurations of the edge system. Runtime information for the ML model may be determined based on heuristics and statistics collected for similar ML models, which can be estimated based on size, in some examples. In other examples, the heuristics and statistics may be based on actual usage statistics from the core ML model deployed on other edge systems. The edge system hardware information may be retrieved from a table or database of edge device hardware information. The ML model application generator 144, the centralized IoT manager 142, or a combination thereof may deploy the ML model application to each respective edge system.

The edge systems may provide the edge data and/or the ML inference data to one or more respective data planes, such as the data plane 152 of the data computing system 150, via the network 130. In some examples, the edge stacks may be configured to implement respective data plane communication interfaces, including application programming interfaces (APIs), to communicate with the one or more data planes. The data plane 152 may be configured to store the edge data, process the edge data, aggregate the edge data across the IoT system 100, provide access to the edge data to clients, or any combination thereof. The edge data received and processed at the data plane 152 may provide insight into events, trends, health, etc., of the IoT system 100 based in data captured by the data sources.

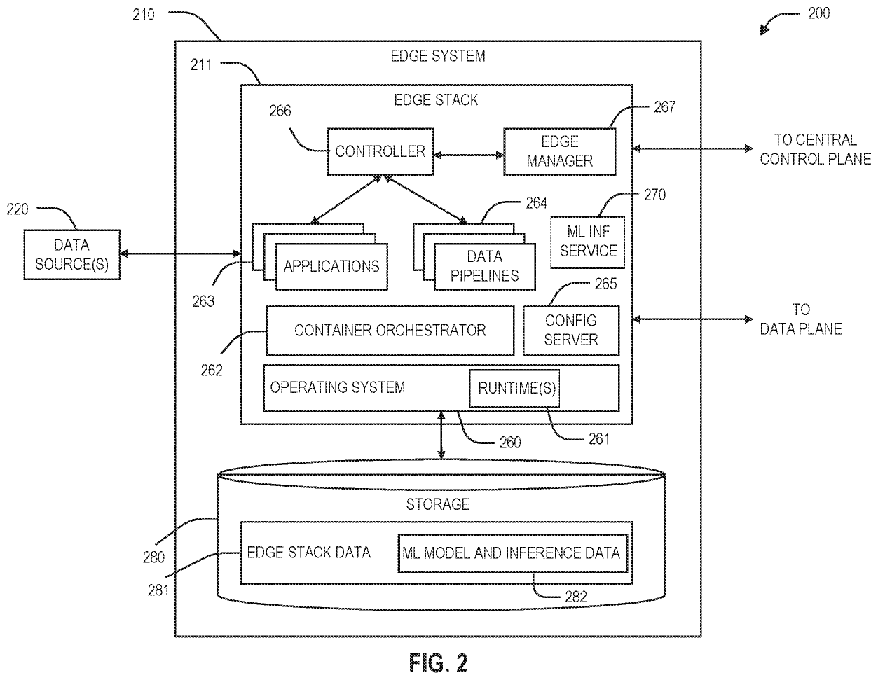

FIG. 2 is a block diagram of an edge computing system 200 of an IoT system, in accordance with an embodiment of the present disclosure. The edge computing system 200 may include an edge device/cluster/VM (edge system) 210 configured to host an edge stack 211 and storage 280. Any of the edge cluster(s) 110, the edge device(s) 112, and/or the edge VM(s) 115 of FIG. 1 may implement a respective version of the edge system 210. Any of the edge stack 111, the edge stack 113, and/or the edge stack 116 of FIG. 1 may implement some or all of the edge stack 211.

In some examples, the edge system 210 may include a respective cluster of computing nodes or devices that are configured to host a respective edge stack 211, with the edge stack 211 distributed across multiple computing nodes, devices, or VMs of the edge system 210. In some examples, the edge system 210 may be a single computing device configured to host the edge stack 211. In some examples, the edge system 210 may include a VM hosted on a server (e.g., or other host machine) that is configured to host the edge stack 211.

The storage 280 may be configured to store edge stack data 281, such as software images, binaries and libraries, metadata, etc., to be used by the edge system 210 to load and execute the edge stack. In some examples, the edge stack data 281 includes instructions that when executed by a process or the edge system 210, causes the edge system to perform functions described herein. The storage may include local storage (solid state drives (SSDs), hard disk drives (HDDs), flash or other non-volatile memory, volatile memory, or any combination thereof), cloud storage, networked storage, or any combination thereof.

The edge stack 211 includes a package hosted on a physical layer of the edge system 210 to facilitate communication with one or more data sources) 220, other edge systems, a centralized IoT manager (e.g., the centralized IoT manager 142 of FIG. 1) via a control plane, and/or a data plane (e.g., the data plane 152 of FIG. 1). The data source(s) 220 may each include one or more devices configured to receive and/or generate respective source data. The data source(s) 220 may include sensors (e.g., electrical, temperature, matter flow, movement, position, biometric data, or any other type of sensor), cameras, transducers, any type of RF receiver, or any other type of device configured to receive and/or generate source data.

The edge stack 211 may host an underlying operating system 260 configured to interface the physical layer of the edge system 210. In some examples, a controller 266, an edge manager 267, a container orchestrator 262, and a configuration server 265 may run on the operating system 260. In some examples, the edge stack 211 may include a bare metal implementation that runs the operating system 260 directly on the physical layer. In other examples, the edge stack 211 may include a virtualized implementation with a hypervisor running on the physical layer and the operating system 260 running on the hypervisor.

The container orchestrator 262 may be configured to manage a containerized architecture of one or more applications 263 and/or one or more data pipelines 264. In some examples, the container orchestrator 262 may include Kubernetes® container orchestration software.

The edge manager 267 may communicate with the centralized IoT manager via the control plane to receive network configuration and communication information, data plane information, software packages for installation (e.g., including the applications 263 and the data pipelines 264), data source connectivity information, etc. In some examples, the edge manager 267 may also be configured to provide configuration and status information to the centralized IoT manager, including status information associated with one or more of the data source(s) 220.

In response to information received from the centralized IoT manager, the edge manager 267 may be configured to provide instructions to the controller 266 to manage the applications 263, the data pipelines 264, and ML models supported by a 270, which may include causing installation or upgrading of one of the applications 263, the data pipelines 264, or the ML models; removing one of the applications 263, the data pipelines 264, or ML models; starting or stopping new instances of the applications 263 or the data pipelines 264; allocating hardware resources to each of the applications 263, the data pipelines 264, or the ML models; or any combination thereof. The edge stack data 281 may include application and data pipeline data that includes data specific to the respective applications 263 and/or the data pipelines 264 to facilitate execution and/or the Mt model and inference data 282 that includes Mt model inference data and/or inference results and/or performance statistics.

As previously described, the applications 263 and the data pipelines 264 may be implemented using a containerized architecture to receive source data from one or more of the data source(s) 220 (e.g., or from others of the applications 263 and/or the data pipelines 264) and to provide respective transformed data at an output by applying a respective function or algorithm to the received source data. In some examples, any user-specified or defined function or algorithm. In some examples, the applications 263 and the data pipelines 264 may be constructed from other computing primitives and building blocks, such as VMs, processes, etc., or any combination of containers, VMs, processes, etc. The applications 263 and data pipelines 264 may each be formed in a respective “sandbox” and may include a group of containers that communicate with each other via a virtual intra-“sandbox” network (e.g., a pod).

In some examples, the data pipelines 264 may be constructed using a group of containers (e.g., a pod) that each perform various functions within the data pipeline 264 (e.g., subscriber, data processor, publisher, connectors that transform data for consumption by another container within the application or pod, etc.) In some examples, the definition of stages of a constructed data pipeline 264 application may be described using a user interface or REST API, with data. ingestion and movement handled by connector components built into the data pipeline. Thus, data may be passed between containers of a data pipeline 264 using API calls.

The 270 may be configured to load and execute respective ML model applications to provide inferences or predictions. In sonic examples, the ML model applications may each be formed in a respective “sandbox” and may include a group of containers that communicate with each other via a virtual intra-“sandbox” network (e.g., a pod). The 270 may retrieve ML model and inference data 282 from the storage 280. The 270 may receive a request for an inference or prediction using a ML model and may load a ML model application that includes the requested ML model into an inference engine. The inference engine may be configured to select a runtime based on a hardware configuration of the edge system, and execute the ML model on input data to provide inference or prediction data. The inference data may be stored as the ML model and inference data 282 and/or may be provided at an output of the edge system 210. In some examples, the inference engine may include multiple executors each configured to execute the ML model according to different runtime configurations. The inference engine may be configured to optimize the ML model for execution based on a hardware configuration. The inference engine may communicate with a remote procedure call (RPC) server to send and receive data associated with loading, executing, providing results, etc. associated with the ML model. A respective inference master of each of the 270 may be configured to manage inference engines, including starting inference engines, stopping inference engines, allocation of a particular ML model application to an inference engine, allocation of hardware resources to each inference engines (e.g., processor usage and memory, and in an edge cluster, which computing node is assigned the inference engine), assigning user/client requests to a particular inference engine, or any combination thereof.

In some examples, the applications 263 and/or the data pipelines 264 may cause the edge data to be provided to a respective destination data plane (e.g., such as the data plane 152 of FIG. 1) or to another edge device via the edge manager 267.

In some examples, the configuration server 265 may be configured to bootstrap the edge stack 211 for connection to a central control plane (e.g., to communicate with the centralized IoT manager) during initial deployment of the edge system 210.

In operation, the edge stack 211 hosted on the edge system 210 may control operation of the edge system 210 with an IoT system to facilitate communication with one or more data source(s) 220 and/or a data plane based on instructions provided from a centralized IoT manager via a control plane. The edge manager 267 of the edge stack 211 may communicate with the centralized IoT manager via the control plane to send configuration and/or status information (e.g., of the edge system 210 and/or one or more of the data source(s) 220) and/or to receive network configuration and communication information, data plane information, software packages for installation (e.g., including the applications 263 and the data pipelines 264), data source connectivity information, etc. In response to information received from the centralized IoT manager, the edge manager 267 may be configured to provide instructions to the controller 266 to manage the applications 263, the data pipelines 264, and/or the 270, which may include causing installation or upgrading of one of the applications 263, the data pipelines 264, or ML model applications; removing one of the applications 263, the data pipelines 264, or ML model applications; starting or stopping new instances of the applications 263 or the data pipelines 264, allocating hardware resources to each of the applications 263 and/or the data pipelines 264, storing data in and/or retrieving data from the edge stack data 281 and/or the ML model and inference data 282, or any combination thereof.

The applications 263 and the data pipelines 264 may receive source data from one or more of the data source(s) 220 (e.g., or from others of the applications 263 and/or the data pipelines 264) and to provide respective transformed data at an output by applying a respective function or algorithm to the received source data. In some examples, the respective algorithms or functions may include machine learning (ML) or artificial intelligence (AI) algorithms. In some examples, the applications 263 and/or the data pipelines 264 may cause the received and/or processed source data to be provided to a respective destination data plane (e.g., such as the data plane 152 of FIG. 1) via the configuration server 265. In some examples, the applications 263 and/or the data pipelines 264 may be implemented using a containerized architecture deployed and managed by the container orchestrator 262. Thus, the container orchestrator 262 may deploy, start, stop, and manage communication with the applications 263 and/or the data pipelines 264 within the edge stack 211.

The 270 may work in conjunction with the data pipelines and applications to assist with processing data, in some examples. In some examples, the 270 may process data independent of the data pipelines and applications. The 270 may receive a request for an inference or prediction from a particular ML model, and to load a ML model application that includes the requested ML model into an inference engine in response to the request.

The inference engine may be configured to select a runtime based on a hardware configuration of the 210, and execute the ML model on input data to provide inference or prediction data. The inference data may be stored at the NIL model and inference data 282 and/or may be provided at an output, such as to a data plane or to a data pipeline or application. In some examples, the inference engine may include multiple executors each configured to execute the ML model according to a different runtime. The inference engine may be configured to optimize the ML model for execution based on a hardware configuration, and in some examples, may track and store statistics associated with execution of the ML model on a data set (e.g., processor usage, time, memory usage, etc.).

The inference engine may communicate with the RPC to send and receive data associated with loading, executing, providing results, etc. associated with the ML model. A respective inference master of the 270 may be configured to manage inference engines, including starting inference engines, stopping inference engines, allocation of a particular ML model to an inference engine, allocation of hardware resources to each inference engines (e.g., processor usage and memory, and in an edge cluster, which computing node is assigned the inference engine), assigning user client requests to a particular inference engine, or any combination thereof.

The edge stack 211 may interface with one or more respective data planes (e.g., or other edge systems) to send data from and receive data at the edge system 210 using respective data plane communication interfaces, including APIs. Thus, the edge stack 211 may route transformed data from the applications 263 and/or the data pipelines 264 to a data plane (e.g., or another edge system) as edge data. The edge stack 211 may also send at least some of the NIL, model and inference data 282 generated by the 270 to the data plane.

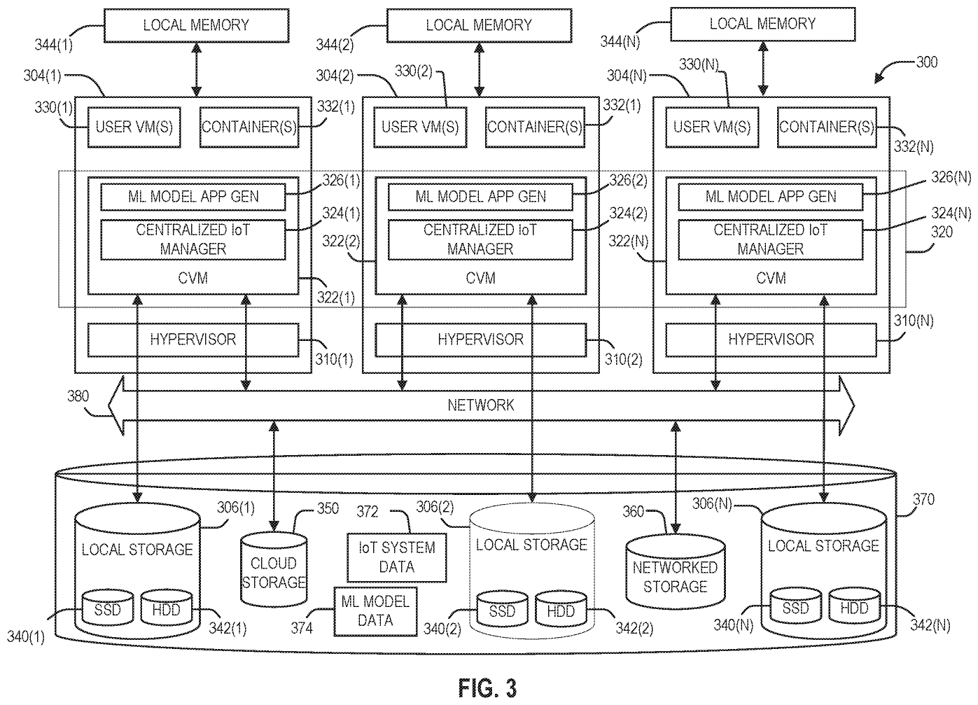

FIG. 3 is a block diagram of a distributed computing system 300, in accordance with an embodiment of the present disclosure. The distributed computing system 300 generally includes computing nodes (e.g., host machines, servers, computers, nodes, etc.) 304(1)-(N) and storage 370 connected to a network 380. While FIG. 3 depicts three computing nodes, the distributed computing system 300 may include two or more than three computing nodes without departing from the scope of the disclosure. The network 380 may be any type of network capable of routing data transmissions from one network device (e.g., computing nodes 304(1)-(N) and the storage 370) to another. For example, the network 380 may be a local area network (LAN), wide area network (WAN), intranet, Internet, or any combination thereof. The network 380 may be a wired network, a wireless network, or a combination thereof. The central IoT computing system 140 of FIG. 1 may be configured to implement the distributed computing system 300, in some examples.

The storage 370 may include respective local storage 306(1)-(N), cloud storage 350, and networked storage 360. Each of the respective local storage 306(1)-(N) may include one or more solid state drive (SSD) devices 340(1)-(N) and one or more hard disk drives (HDD)) devices 342(1)-(N). Each of the respective local storage 306(1)-(N) may be directly coupled to, included in, and/or accessible by a respective one of the computing nodes 304(1)-(N) without communicating via the network 380. The cloud storage 350 may include one or more storage servers that may be stored remotely to the computing nodes 304(1)-(N) and may be accessed via the network 380. The cloud storage 350 may generally include any type of storage device, such as HDDs, SSDs, optical drives, etc. The networked storage (or network-accessed storage) 360 may include one or more storage devices coupled to and accessed via the network 380. The networked storage 360 may generally include any type of storage device, such as HDDs. SSDs, optical drives, etc. In various embodiments, the networked storage 360 may be a storage area network (SAN).

Each of the computing nodes 304(1)-(N) may include a computing device configured to host a respective hypervisor 310(1)-(N), a respective controller virtual machine (CVM) 322(1)-(N), respective user (or guest) virtual machines (VMs) 330(1)-(N), and respective containers 332(1)-(N). For example, each of the computing nodes 304(1)-(N) may be or include a server computer, a laptop computer, a desktop computer, a tablet computer, a smart phone, any other type of computing device, or any combination thereof. Each of the computing nodes 304(1)-(N) may include one or more physical computing components, such as one or more processor units, respective local memory 344(1)-(N) (e.g., cache memory, dynamic random-access memory (DRAM), non-volatile memory (e.g., flash memory), or combinations thereof), the respective local storage 306(1)-(N), ports (not shown) to connect to peripheral input/output (I/O) devices (e.g., touchscreens, displays, speakers, keyboards, mice, cameras, microphones, environmental sensors, etc.).

Each of the user VMs 330(1)-(N) hosted on the respective computing node includes at least one application and everything the user VM needs to execute (e.g., run) the at least one application (e.g., system binaries, libraries, etc.). Each of the user VMs 330(1)-(N) may generally be configured to execute any type and/or number of applications, such as those requested, specified, or desired by a user. Each of the user VMs 330(1)-(N) further includes a respective virtualized hardware stack (e.g., virtualized network adaptors, virtual local storage, virtual memory, processor units, etc.). To manage the respective virtualized hardware stack, each of the user VMs 330(1)-(N) is further configured to host a respective operating system (e.g., Windows®, Linux®, etc.). The respective virtualized hardware stack configured for each of the user VMs 330(1)-(N) may be defined based on available physical resources (e.g., processor units, the local memory 344(1)-(N), the local storage 306(1)-(N), etc.). That is, physical resources associated with a computing node may be divided between (e.g., shared among) components hosted on the computing node (e.g., the hypervisor 310(1)-(N), the CVM 322(1)-(N), other user VMs 330(1)-(N), the containers 332(1)-(N), etc.), and the respective virtualized hardware stack configured for each of the user VMs 330(1)-(N) may reflect the physical resources being allocated to the user VM. Thus, the user VMs 330(1)-(N) may isolate an execution environment my packaging both the user space (e.g., application(s), system binaries and libraries, etc.) and the kernel and/or hardware (e.g., managed by an operating system). While FIG. 3 depicts the computing nodes 304(1)-(N) each having multiple user VMs 330(1)-(N), a given computing node may host no user VMs or may host any number of user VMs.

Rather than providing hardware virtualization like the user VMs 330(1)-(N), the respective containers 332(1)-N) may each provide operating system level virtualization. Thus, each of the respective containers 332(1)-(N) is configured to isolate the user space execution environment (e.g., at least one application and everything the container needs to execute (e.g., run) the at least one application (e.g., system binaries, libraries, etc.)) without requiring a hypervisor to manage hardware. Individual ones of the containers 332(1)-(N) may generally be provided to execute any type and/or number of applications, such as those requested, specified, or desired by a user. Two or more of the respective containers 332(1)-(N) may run on a shared operating system, such as an operating system of any of the hypervisor 310(1)-(N), the CVM 322(1)-(N), or other user VMs 330(1)-(N). In some examples, an interface engine may be installed to communicate between a container and an underlying operating system. While FIG. 3 depicts the computing nodes 304(1)-(N) each having multiple user VMs 330(1)-(N), a given computing node may host no user VMs or may host any number of user VMs.

Each of the hypervisors 310(1)-(N) may include any type of hypervisor. For example, each of the hypervisors 310(1)-(N) may include an ESX, an ESX(i), a Hyper-V, a KVM, or any other type of hypervisor. Each of the hypervisors 310(1)-(N) may manage the allocation of physical resources (e.g., physical processor units, volatile memory, the storage 370) to respective hosted components (e.g., CVMs 322(1)-(N), respective user VMs 330(1)-(N), respective containers 332(1)-(N)) and performs various VM related operations, such as creating new VMs and/or containers, cloning existing VMs, etc. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API. Collectively, the hypervisors 310(1)-(N) may all include a common hypervisor type, may all include different hypervisor types, or may include any combination of common and different hypervisor types.

The CVMs 322(1)-(N) may provide services the respective user VMs 330(1)-(N), and/or the respective containers 332(1)-(N) hosted on a respective computing node of the computing nodes 304(1)-(N). For example, each of the CVMs 322(1)-(N) may execute a variety of software and/or may serve the I/O operations for the respective hypervisor 310(1)-(N), the respective user VMs 330(1)-(N), and/or the respective containers 332(1)-(N) hosted on the respective computing node 304(1)-(N). The CVMs 322(1)-(N) may communicate with one another via the network 380. By linking the CVMs 322(1)-(N) together via the network 380, a distributed network (e.g., cluster, system, etc.) of the computing nodes 304(1)-(N) may be formed. In an example, the CVMs 322(1)-(N) linked together via the network 380 may form a distributed computing environment (e.g., a distributed virtualized file server) 320 configured to manage and virtualize the storage 370. In some examples, a SCSI controller, which may manage the SSD devices 340(1)-(N) and/or the HDD devices 342(1)-(N) described herein, may be directly passed to the respective CVMs 322(1)-(N), such as by leveraging a VM-Direct Path. In the case of Hyper-V, the SSD devices 340(1)-(N) and/or the HDD devices 342(1)-(N) may be passed through to the respective CVMs 322(1)-(N).

The CVMs 322(1)-(N) may coordinate execution of respective services over the network 380, and the services running on the CVMs 322(1)-(N) may utilize the local memory 344(1)-(N) to support operations. The local memory 344(1)-(N) may be shared by components hosted on the respective computing node 304(1)-(N), and use of the respective local memory 344(1)-(N) may be controlled by the respective hypervisor 310(1)-(N) Moreover, multiple instances of the same service may be running throughout the distributed system 300. That is, the same services stack may be operating on more than one of the CVMs 322(1)-(N). For example, a first instance of a service may be running on the CVM 322(1), a second instance of the service may be running on the CVM 322(2), etc.

In some examples, the CVMs 322(1)-(N) may be configured to collectively manage a centralized IoT manager of an IoT system, with each of the CVMs 322(1)-(N) hosting a respective centralized IoT manager instances 324(1)-(N) on an associated operating system to form the centralized IoT manager. In some examples, one of the centralized IoT manager instances 324(1)-(N) may be designated as a master centralized IoT manager instance configured to coordinate collective operation of the centralized IoT manager instances 324(1)-(N). The centralized IoT manager instances 324(1)-(N) may be configured to manage configuration of (e.g., network connectivity information, connected data sources, installed application and other software versions, data pipelines, etc.), as well as generate and distribute data pipelines to edge systems (e.g., any of an edge device of the edge cluster(s) 110, the edge device(s) 112, the edge VM(s) 115 of the server/cluster 114, etc.) of an IoT system centrally manage operation of the IoT system. The centralized IoT manager instances 324(1)-(N) may be configured to interface with multiple edge system types and interfaces via a control plane. To manager the operation of the IoT system, the centralized IoT manager instances 324(1)-(N) may retrieve data from and store data to IoT system data 372 of the storage 370. The IoT system data 372 may include metadata and other data corresponding to each edge system, data source, user, site, etc. within the IoT system. For example, the Ica system data 372 may include hardware configurations, software configurations, network configurations, edge system and/or data source type, categories, geographical and physical locations, authentication information, associations between edge systems and data sources, associations between edge systems and users, user access permissions, etc., or any combination thereof.

In some examples, the CVMs 322(1)-(N) may include a ML model application generator formed from one or more ML model application generator instances 326(1)-(N) that is configured to receive and configure a core ML model for deployment as a ML model application to individual edge systems based on individual configurations of the edge systems. A core ML model may be loaded into one of the ML model application generator instances 326(1)-(N) (e.g., from ML model data 374 of the storage 370), and based on the types of edge systems to which the core ML model is to be deployed, the one of the ML model application generator instances 326(1)-(N) configures a respective version of the ML model to deploy to each different type of edge system to take advantage of specific edge system hardware capabilities. The independent generation of each ML model application by the ML model application generator via the ML model application generator instances 326(1)-(N), may include choosing respective runtime environment settings and memory usage based on specialized hardware (e.g., GPU, TPU, hardware accelerators, VPU, Movidius, etc.) and other hardware configurations of the edge system. Runtime information for the ML model may be determined based on heuristics and statistics collected for similar ML models, which can be estimated based on size. The edge system hardware information may be retrieved from a table or database of edge device hardware information.

Generally, the CVMs 322(1)-(N) may be configured to control and manage any type of storage device of the storage 370, The CVMs 322(1)-(N) may implement storage controller logic and may virtualize all storage hardware of the storage 370 as one global resource pool to provide reliability, availability, and performance. IP-based requests may be generally used (e.g., by the user VMs 330(1)-(N) and/or the containers 332(1)-(N)) to send I/O requests to the CVMs 322(1)-(N). For example, the user VMs 330(1) and/or the containers 332(1) may send storage requests to the CVM 322(1) using an IP request, the user VMs 330(2) and/or the containers 332(2) may send storage requests to the CVM 322(2) using an IP request, etc. The CVMs 322(1)-(N) may directly implement storage and I/O optimizations within the direct data access path.

Note that the CVMs 322(1)-(N) provided as virtual machines utilizing the hypervisors 310(1)-(N). Since the CVMs 322(1)-(N) run “above” the hypervisors 310(1)-(N), some of the examples described herein may be implemented within any virtual machine architecture, since the CVMs 322(1)-(N) may be used in conjunction with generally any type of hypervisor from any virtualization vendor.

Virtual disks (vDisks) may be structured from the storage devices in the storage 370. A vDisk generally refers to the storage abstraction that may be exposed by the CVMs 322(1)-(N) to be used by the user VMs 330(1)-(N) and/or the containers 332(1)-(N). Generally, the distributed computing system 300 may utilize an IP-based protocol, such as an Internet small computer system interface(iSCSI) or a network file system interface (NFS), to communicate between the user VMs 330(1)-(N), the containers 332(1)-(N), the CVMs 322(1)-(N), and/or the hypervisors 310(1)-(N). Thus, in some examples, the vDisk may be exposed via an iSCSI or a. NFS interface, and may be mounted as a virtual disk on the user VMs 330(1)-(N) and/or operating systems supporting the containers 332(1)-(N). iSCSI may generally refer to an IP-based storage networking standard for linking data storage facilities together. By carrying SCSI commands over IP networks, iSCSI can be used to facilitate data transfers over intranets and to manage storage over any suitable type of network or the Internet. The iSCSI protocol may allow iSCSI initiators to send SCSI commands to iSCSI targets at remote locations over a network. NFS may refer to an IP-based file access standard in which NFS clients send file-based requests to NFS servers via a proxy folder (directory) called “mount point”.

During operation, the user VMs 330(1)-(N) and/or operating systems supporting the containers 332(1)-(N) may provide storage input/output (I/O) requests to the CVMs 322(1)-(N) and/or the hypervisors 310(1)-(N) via iSCSI and/or NFS requests. Each of the storage I/O requests may designate an IP address for a CVM of the CVMs 322(1)-(N) from which the respective user VM desires I/O services. The storage I/O requests may be provided from the user VMs 330(1)-(N) to a virtual switch within a hypervisor of the hypervisors 310(1)-(N) to be routed to the correct destination. For examples, the user 330(1) may provide a storage request to the hypervisor 310(1). The storage request may request I/O services from a CVM of the CVMs 322(1)-(N). If the storage I/O request is intended to be handled by a respective CVM of the CVMs 322(1)-(N) hosted on a same respective computing node of the computing nodes 304(1)-(N) as the requesting user VM (e.g., CVM 322(1) and the user VM 330(1) are hosted on the same computing node 304(1)), then the storage I/O request may be internally routed within the respective computing node of the computing node of the computing nodes 304(1)-(N). In some examples, the storage I/O request may be directed to respective CVM of the CVMs 322(1)-(N) on another computing node of the computing nodes 304(1)-(N) as the requesting user VM (e.g., CVM 322(1) is hosted on the computing node 304(1) and the user VM 330(2) is hosted on the computing node 304(2)). Accordingly, a respective hypervisor of the hypervisors 310(1)-(N) may provide the storage request to a physical switch to be sent over the network 380 to another computing node of the computing nodes 304(1)-(N) hosting the requested CVM of the CVMs 322(1)-(N).

The CVMs 322(1)-(N) may collectively manage the storage I/O requests between the user VMs 330(1)-(N) and/or the containers 332(1)-(N) of the distributed computing system and a storage pool that includes the storage 370. That is, the CVMs 322(1)-(N) may virtualize I/O access to hardware resources within the storage pool. In this manner, a separate and dedicated CVM of the CVMs 322(1)-(N) may be provided each of the computing nodes 304(1)-(N) the distributed computing system 300. When a new computing node is added to the distributed computing system 300, it may include a respective CVM to share in the overall workload of the distributed computing system 300 to handle storage tasks. Therefore, examples described herein may be advantageously scalable, and may provide advantages over approaches that have a limited number of controllers. Consequently, examples described herein may provide a massively-parallel storage architecture that scales as and when computing nodes are added to the system.

The distributed system 300 may include a centralized IOT manager that includes one or more of the centralized IoT manager instances 324(1)-(N) hosted on the CVMs 322(1)-(N). The centralized IoT manager may be configured to centrally manage configuration of edge systems and data sources of the corresponding IoT system. In some examples, the centralized IoT manager may be configured to manage, for each of the edge systems, data sources, and/or users, network configuration and security protocols, installed software (e.g., including data pipelines and applications), connected data source(s) (e.g., including type, category, identifiers, data communication protocols, etc.), connected data plane(s), etc. The centralized IoT manager may maintain configuration information for each of the edge systems, data sources, associated users, including hardware configuration information, installed software version information, connected data source information (e.g., including type, category, identifier, etc.), associated data planes, current operational status, authentication credentials and/or keys, etc.

In some examples, a workload of the centralized IoT manager may be distributed across two or more of the computing nodes 304(1)-(N) via the respective centralized IoT manager instances 324(I)-(N). In other examples, the workload of the centralized IoT manager may reside in a single one of the centralized IoT manager instances 324(1)-(N). A number of centralized IoT manager instances 324(1)-(N) running on the distributed computing system 300 may depend on a size of the management workload associated with the IoT system (e.g., based on a number of edge systems, data sources, users, etc., level of activity within the IoT system, frequency of updates, etc.), as well as compute resources available on each of the computing nodes 304(1)-(N). One of the centralized IoT manager instances 324(1)-(N) may be designated a master centralized server manager that is configured to monitor workload of the centralized IoT manager instances 324(1)-(N), and based on the monitored workload, allocate management of respective edge systems and users to each of the centralized IoT manager instances 324(1)-(N) and start additional centralized IoT manager instances when compute resources available to the centralized IoT manager have fallen below a defined threshold. Thus, while FIG. 3 depicts each of the CVMs 322(1)-(N) hosting a respective one of the centralized IoT manager instances 324(I)-(N), it is appreciated that some of the CVMs 322(1)-(N) may not have an active centralized IoT manager instances 324(1)-(N) running without departing from the scope of the disclosure.

In some examples, the centralized IoT manager may be configured to generate or update and distribute data pipelines and applications to selected edge systems based on the configuration maintained for each edge system. In some examples, the centralized IoT manager may facilitate creation of one or more project constructs and may facilitate association of a respective one or more edge systems with a particular project construct in response to user input and/or in response to criteria or metadata of the particular project). Each edge systems may be associated with no project constructs, one project construct, or more than one project construct. A project construct may be associated with any number of edge systems. When a data pipeline is created, the centralized IoT manager may assign the data pipeline to or associate the data pipeline with a respective one or more project constructs. In response to the assignment to or association with the respective one or more project constructs, the centralized IoT manager 142 may deploy the data pipeline to each edge system associated with the respective one or more project constructs. Each data pipeline may be formed in a respective “sandbox” and include a group of containers that communicate with each other via a virtual intra-“sandbox” network (e.g., a pod).

In some examples, a workload of the ML model application generator may be distributed across two or more of the computing nodes 304(1)-(N) via the respective ML model application generator instances 326(1)-(N). In other examples, the workload of the ML model application generator may reside in a single one of the ML model application generator instances 326(1)-(N). A number of ML model application generator instances 326(1)-(N) running on the distributed computing system 300 may depend on a size of the management workload associated with ML generation within the IoT system (e.g., based on a number of edge systems, data sources, users, etc., level of activity within the IoT system, frequency of updates, etc.), as well as compute resources available on each of the computing nodes 304(1)-(N).

The ML model application generator may receive and configure a core ML model as a ML model application for deployment to individual edge systems based on individual configurations of the edge systems. In some examples, the request to configure the core ML model as a ML mode inference may be received from the centralized IoT manager (e.g., via one of the centralized IoT manager instances 324(1)-(N). In other examples, the request may be received directly from a user. In response to the request, a core ML model may be loaded into one of the ML model application generator instances 326(1)-(N) (e.g., from a user or from the ML model data 374). Based on the types of edge systems to which the core ML model is to be deployed (e.g., determined based on an associated project construct or some other criteria specified in the ML model or by a user), the one of the ML model application generator instances 326(1)-(N) configures a respective version of the ML model application to deploy to each different type of edge system to take advantage of specific edge system hardware capabilities, in some examples. In other examples, the one of the ML model application generator instances 326(1)-(N) may configure the ML model application to allow each edge system to which the ML model application is deployed to choose an execution path that uses respective runtime environment settings and memory usage corresponding to specialized hardware and other hardware configurations of the respective edge system.

The independent generation of each ML model application by the ML model application generator, may include choosing or including respective runtime environment settings and memory usage based on specialized hardware (e.g., GPU, TPU, hardware accelerators, VPU, Movidius, etc.) and other hardware configurations of each edge system to which the ML model application is to be deployed. Runtime information for the ML model may be determined based on heuristics and statistics collected for similar ML models, which can be estimated based on size, in some examples. In other examples, the heuristics and statistics may be based on actual usage statistics from the core ML model deployed on other edge systems. The edge system hardware information may be retrieved from a table or database of edge device hardware information. The ML model application generator, the centralized IoT manager, or a combination thereof may deploy the ML model application to one or more respective edge system.

Constructing independent ML model applications for each respective edge system based on a hardware configuration information of the edge system may improve efficiency in executing the ML model at the edge system as compared with generic or non-specific ML model applications.

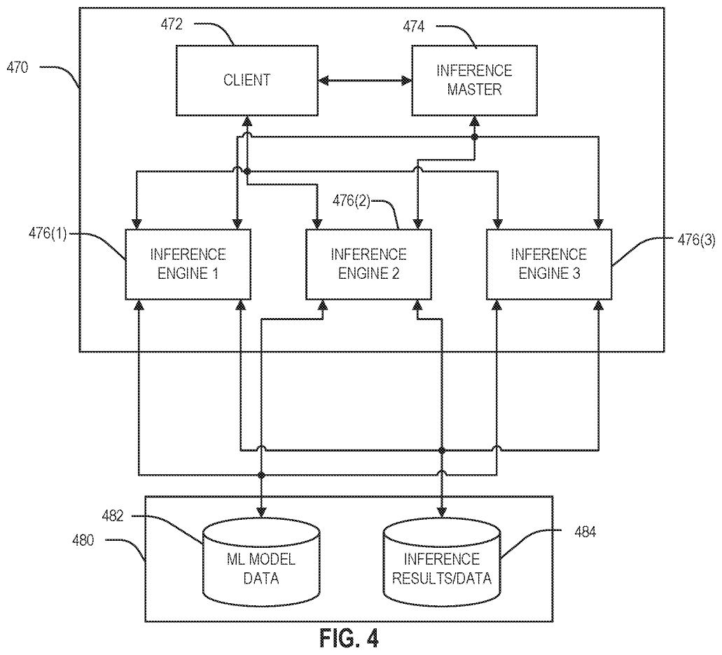

FIG. 4 is a block diagram of a ML inference service 470 and storage 480, in accordance with an embodiment of the present disclosure. Any of the ML inference services 161(1)-(3) of FIG. 1 and/or the 270 of FIG. 2 may implement the ML inference service 470, in some examples. The ML model and inference data 282 of FIG. 2 may implement the storage 480, in some examples.

The ML inference service 470 may include a client 472, an inference master 474, and inference engines 476(1)-(3). The client 472 may be configured to receive requests to process a data set via a ML model from a user or another application or data pipeline. The ML inference service 470 and/or any of the client 472, the inference master 474, and/or the inference engines 476(1)-(3) may each be formed in a respective “sandbox” and include a group of containers that communicate with each other via a virtual intra-“sandbox” network (e.g., a pod). The client 472 may include a library used to connect and call inference or prediction requests using ML models included in ML model applications. The client 472 may be available in different languages, in some examples.

The inference master 474 has global knowledge about some or all of the inference engines 476(1)-(3) (e.g., on the edge system, including across nodes of an edge cluster). Using this knowledge, the inference master 474 can make sophisticated decisions on ML model placement and number of replicas needed for each ML model. To check whether the inference engines 476(1)-(3) are operational, the inference master 474 may periodically sends heartbeat messages to each of the inference engines 476(1)-(3). Based on various parameters, such as processing time or memory usage, the inference master 474 may determine which ML model is to run on a given one of the inference engines 476(1)-(3). The inference master 474 may also start additional inference engines or stop some inference engines based on demand. Estimating computational requirements for a given ML model may be approximated based on a number of floating point operations per second (FLOPS) required per request and the memory requirements may be based on a file size of the given ML model. Once the inference master 474 has assigned a ML model to a particular one of the inference engines 476(1)-(3), the client 472 may communicate directly with the particular one of the inference engines 476(1)-(3).

The inference engines 476(1)-(3) may service ML model inference or prediction requests from the client 472. During startup, each of the inference engines 476(1)-(3) sends a join request to the inference master 474. The inference master 474 sends the ML model configuration data (e.g., including the information about the different models that the inference engine should run). For a given one of the inference engines 476(1)-(3), a selected computational framework may be used, such as Tensorflow® serving developed by Google®. In some examples, the inference engines 476(1)-(3) may include a respective configurator that receives ML model configuration changes from the inference master 474 and applies the changes to the respective inference engine 476(1)-(3). The configurator may also collect hardware and memory stats from the respective inference engine 476(1)-(3) and stores as inference results/data 484, such as in a database.

In an example workflow, the client 472 may send an identifier associated with a ML model (e.g., ML model name, version, etc.) to the inference master 474. If none of the inference engines 476(1)-(3) are currently servicing the specified ML model, the inference master 474 may send a ML model configuration request to one of the inference engines 476(1)-(3).The inference master 474 may then reply back to the client 472 with a location of the ML model. The client 472 may then then send a prediction or inference request directly to the one of the inference engines 476(1)-(3). The one of the inference engines 476(1)-(3) may execute the ML model and may provide results to the inference results/data 484.

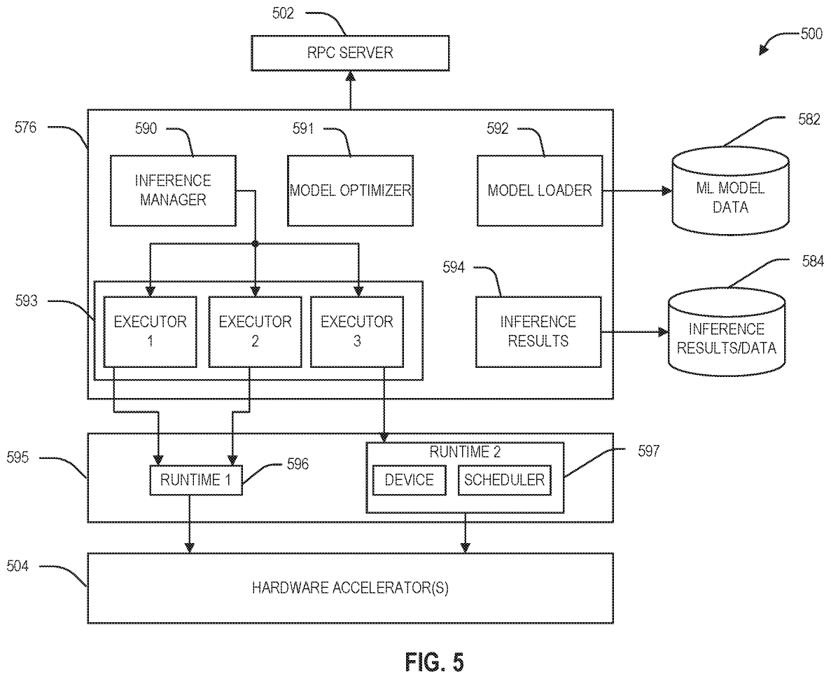

FIG. 5 is a block diagram of an exemplary ML inference architecture 500, in accordance with an embodiment of the present disclosure. Any of the ML inference services 161(1)-(3) of FIG. 1, the 270 of FIG. 2, and/or the ML inference service 470 and storage 480 of FIG. 4 may implement the ML inference architecture 500, in some examples. The MIL model and inference data 282 of FIG. 2 and/or the ML model data 482 of FIG. 4 may implement the ML model data 582, in some examples. The ML model and inference data 282 of FIG. 2 and/or the inference results/data 484 of FIG. 4 may implement the inference results/data 584, in some examples.

The ML inference architecture 500 may be implemented in a modular fashion to include an inference engine 576, inference results 594, and hardware accelerators 504. The hardware accelerators may include execution hardware components, such as GPUs, TPUs, VPUs, etc. In some examples, the ML inference architecture 500 may further include a remote procedure call (RPC) server 502 to manage communication between the inference engine 576, the runtime environments 595, and the hardware accelerators 504. The RPC server 502 may be based on RPC. The RPC server 502 may accept connections from clients and may forward the connections to the inference engine 576. The inference engine 576, the inference results 594, and the hardware accelerators 504 may each be formed in a respective “sandbox” and include a group of containers that communicate with each other via a virtual intra-“sandbox” network (e.g., a pod). The RPC server 502 may support persistent connection, such that a single connection is opened for sending inference requests.

The inference engine 576 may include comprises different modules, such as an inference manager 590, a model optimizer 591, a model loader 592, one or more executors 593 and inference results 594. The inference engine 576 may be responsible for handling a prediction or inference request and executing the request on a runtime particular runtime of the inference results 594. In some examples, the inference engine 576 may choose an appropriate first runtime environment 596 or a second runtime environment 597 of the runtime environments 595 to execute the job. The inference engine 576 may also manage a ML model's life cycle.

Each of the executors 593 may be essentially a client that connects to one of the runtime environments 595 and executes the ML model, Since there multiple runtimes runtime environments 595 and 596, there may be several different kinds of clients. For every ML model and version, the inference engine 576 may create a separate executors 593 (e.g., client). While FIG. 5 depicts three of the executors 593, more or fewer model executors may be included in the system without departing from the scope of the disclosure.

The inference manager 590 may handle routing of a prediction or inference request and may maintain a map of the ML model and version to a respective one of the executors 593. When the inference request is received, the inference manager 590 may choose a respective one of the executors 593 to which to route the inference request.

The inference manager 590 may also manage a lifecycle of the. ML models. When a new ML model or a new version of an existing ML model is added, the inference manager 590 may create a new one of the executors 593 and add the new one of the executors 593 to the map. The model loader 592 may interface with storage to load the ML model data 582 (e.g., Object store/File system) to load relevant files when the new model is added, and the model optimizer 591 may optimize the ML model for a respective runtime associated with the new one of the executors 593. The inference manager 590 may also make a decision on which of the executors 593 to create for a given ML model. The decision may be made based on a ML model type and resource utilization on different ones of the runtime environments 595.

Each of the executors 593 may occupy memory of the hardware accelerators 504 (e.g., TPU/VPU/GPU/CPU memory). Thus, the inference manager 590 may collect statistics on memory usage of the hardware accelerators 504 and if there is no space available one type of the hardware accelerators 504, then the inference manager 590 may direct one of the executors 593 to run on a different one of the hardware accelerators 504. The inference results 594 may be configured to retrieve and store the inference results as inference results/data 584. The inference results/data 584 may be stored in a database, in some examples. The inference results/data 584 may be useful to improve the accuracy of a MIL model. The inference engine 576 may compare the results with the expected output and use the comparison to train a new ML model, in some examples.

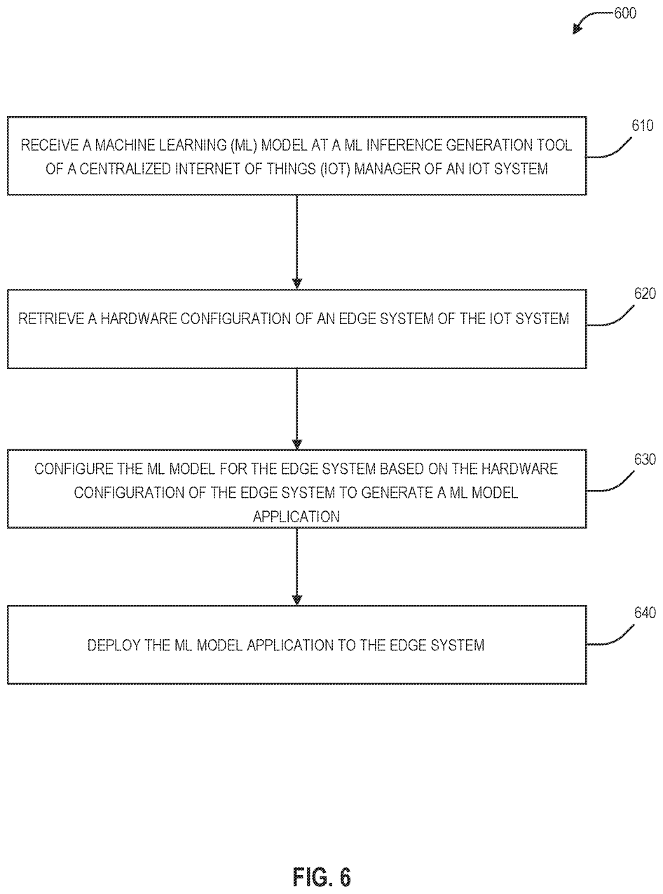

FIG. 6 is a flow diagram of a method 600 to generate and deploy a machine learning inference service, in accordance with an embodiment of the present disclosure. The method 600 may be performed by either or both of the centralized IoT manager 142 or the ML model application generator 144 of FIG. 1, either of the centralized IoT manager instances 324(1)-(N) or the ML model application generator instances 326(1)-(N) of FIG. 3, or any combination thereof.

The method 600 may include receiving a machine learning (ML) model at a ML inference generation tool of a centralized Internet of Things (IoT) manager of an IoT system, at 610. The IoT system may include the system 100 of FIG. 1. The ML inference generation tool may include the ML model application generator 144 of FIG. 1 and/or the ML model application generator instances 326(1)-(N) of FIG. 3. The ML model may be stored as ML model data, such as the ML model data 374 of FIG. 3.

The method 600 may further include retrieving a hardware configuration of an edge system of the IoT system, at 620. The hardware configuration may include execution hardware components, memory, etc. of the edge system. The edge system may include any of the edge cluster(s) 110, the edge device(s) 112, and/or the edge VM(s) 115 of FIG. 1 and/or the edge system 210 of FIG. 2.

The method 600 may further include configuring the ML model for the edge system based on a hardware configuration of the edge system to generate a ML model application, at 630. In some examples, the method 600 may further include providing a run time environment in the ML model application that is associated with a hardware component of the hardware configuration. In some examples, the method 600 may further include providing a second run time environment in the ML model application associated with a second execution hardware component of the hardware configuration of the edge system. The runtime environments may include the first runtime environment 596 and/or the second runtime environment 597 of FIG. 5. Each runtime environment may be tied to a specific execution hardware component of the edge system, such as the hardware accelerators 504 of FIG. 5. Examples of execution hardware components may include at least one of a GPU, a TPU, a hardware accelerator, a VPU, a CPU, or any combination thereof.

In some examples, the method 600 may further include configuring the ML model application for the edge system is further based on ML model metrics. In some examples, the method 600 may further include evaluating the ML model to determine the ML model metrics. The ML model metrics include floating point operations per second, a size of the ML model, or combinations thereof. The method 600 may further include deploying the ML model application to the edge system, at 640.

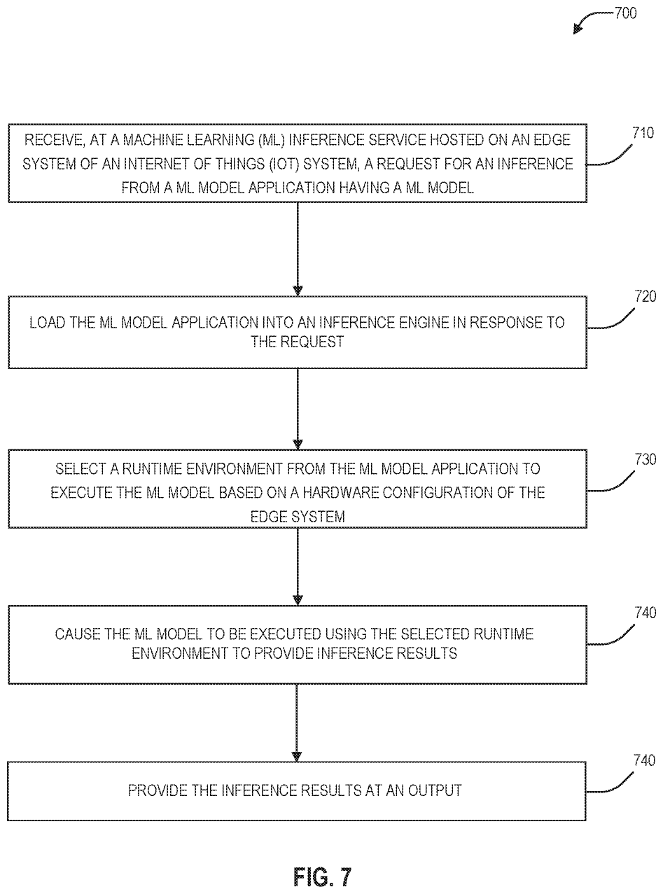

FIG. 7 is a flow diagram of a method 700 to execute a ML model at a ML inference service of an edge system, in accordance with an embodiment of the present disclosure. The method 700 may be performed by any of the edge cluster(s) 110, the edge device(s) 112, and/or the edge VM(s) 115 of FIG. 1 and/or the edge system 210 of FIG. 2, or any combination thereof. The ML inference service may include any of the ML inference services 161(1)-(3) of FIG. 1, the 270 of FIG. 2., the ML inference service 470 of FIG. 4, one or more components of the ML inference architecture 500 of FIG. 5, or combinations thereof.

The method 700 may include receiving a machine learning (ML) inference service hosted on an edge system of a centralized Internet of Things (IoT) manager of an IoT system, a request for an inference from a ML model application having a ML model, at 710. The IoT system may include the system 100 of FIG. 1. The request may be received from a client, such as the client 472 of FIG. 4. The request for the inference from the ML model application having the ML model includes an identifier associated with the ML model and/or a version of the ML model, in some examples.

The method 700 may further include loading the ML model application into an inference engine in response to the request, at 720. The inference engine may include any of the inference engines 476(1)-(3) of FIG. 4 and/or the inference engine 576 of FIG. 5. The ML model application may be loaded from storage, such as loading the ML model and inference data 282 from the 280 of FIG. 2 and/or loading the ML model data 482 from the storage 480 of FIG. 4. In some examples, the method 700 may further include loading the ML model application into an inference engine in response to a determination that the ML model application is unavailable in other inference engines. In some examples, the method 700 may further include mapping the ML model application to the inference engine. In some examples, the method 700 may further include directing a second request for an inference from the ML model application to the inference engine in response to a determination that the ML model application is mapped to the inference engine. The mapping of the ML model to an inference engine may be performed by an inference master, such as the inference master 474 of FIG. 4.

The method 700 may further include selecting a runtime environment from the ML model application to execute the ML model based on a hardware configuration of the edge system, at 730. In some examples, the method 700 may further include selecting the runtime environment associated with a first execution hardware component in response to a second execution hardware component being unavailable. In some examples, the method 700 may further include selecting a different runtime environment for execution of the second request. The runtime environments may include the first runtime environment 596 and/or the second runtime environment 597 of FIG. 5. Each runtime environment may be tied to a specific execution hardware component of the edge system, such as the hardware accelerators 504 of FIG. 5. Examples of execution hardware components may include at least one of a GPU, a TPU, a hardware accelerator, a VPU, a CPU, or any combination thereof.

The method 700 may further include causing the ML model to be executed using the selected runtime environment to provide inference results, at 740. In some examples, the method 600 may further include evaluating the ML model to determine the ML model metrics. The ML model metrics include floating point operations per second, a size of the ML model, or combinations thereof. The method 700 may further include providing the inference results at an output, at 750.

The methods 600 and 700 may be implemented as instructions stored on a computer readable medium (e.g., memory, disks, etc.) that are executable by one or more processor units (e.g., central processor units (CPUs), graphic processor units (CPUs), tensor processing units (TPUs), hardware accelerators, video processing units (VPUs), etc. to perform the methods 600 and 700.

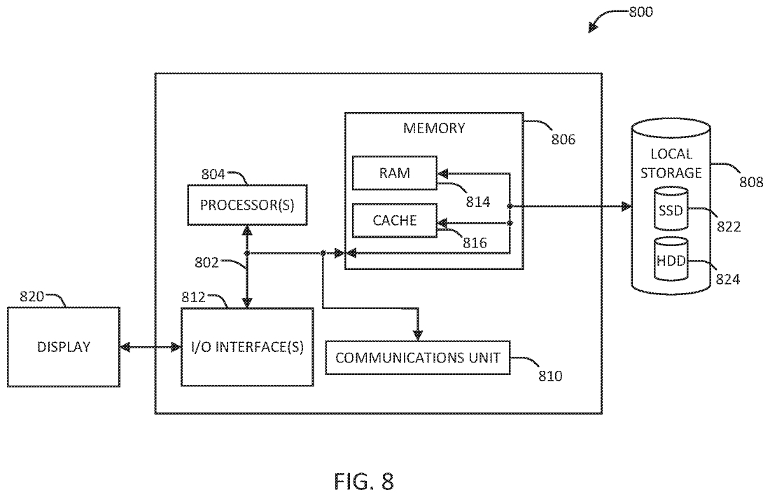

FIG. 8 depicts a block diagram of components of an edge system and/or a computing node (device) 800 in accordance with an embodiment of the present disclosure. It should be appreciated that FIG. 8 provides only an illustration of one implementation and does not imply any limitations with regard to the environments in which different embodiments may be implemented. Many modifications to the depicted environment may be made. The device 800 may implemented as any of an edge device of the edge cluster(s) 110, the edge device(s) 112, the server/cluster 114, a computing node of the central IoT computing system 140, or a computing node of the data computing system 150 of FIG. 1, all or part of the edge computing system 200 of FIG. 2, any of the computing nodes 304(1)-(N) of FIG. 3, devices configured host any of the machine learning inference service ML inference service 470 or data storage 480 of FIG. 4, devices configured to implement the machine learning inference architecture 500 of FIG. 5, or any combination thereof. The device 800 may be configured to implement the method 800 of FIG. 8 to generate and distribute a machine learning inference in an IoT system. The device 800 may be configured to implement the method 800 of FIG. 8 to execute a machine learning model at a machine learning inference service of an edge system.

The device 800 includes a communications fabric 802, which provides communications between one or more processor(s) 804, memory 806, local storage 808, communications unit 810, I/O interface(s) 812. The communications fabric 802 can be implemented with any architecture designed for passing data and/or control information between processors (such as microprocessors, communications and network processors, etc.), system memory, peripheral devices, and any other hardware components within a system. For example, the communications fabric 802 can be implemented with one or more buses.

The memory 806 and the local storage 808 are computer-readable storage media, in this embodiment, the memory 806 includes random access memory RAM 814 and cache 816. In general, the memory 806 can include any suitable volatile or non-volatile computer-readable storage media. The local storage 808 may be implemented as described above with respect to local storage 224 and/or local storage network 240 of FIGS. 2-4. In this embodiment, the local storage 808 includes an SSD 822 and an HDD 824, which may be implemented as described above with respect to any of SSD 340(1)-(N) and any of HDD 342(1)-(N), respectively.

Various computer instructions, programs, files, images, etc. may be stored in local storage 808 for execution by one or more of the respective processor(s) 804 via one or more memories of memory 806. In some examples, local storage 808 includes a magnetic HDD 824. Alternatively, or in addition to a magnetic hard disk drive, local storage 808 can include the SSD 822, a semiconductor storage device, a read-only memory (ROM), an erasable programmable read-only memory (EPROM), a flash memory, or any other computer-readable storage media that is capable of storing program instructions or digital information.

The media used by local storage 808 may also be removable. For example, a removable hard drive may be used for local storage 808. Other examples include optical and magnetic disks, thumb drives, and smart cards that are inserted into a drive for transfer onto another computer-readable storage medium that is also part of local storage 808.

Communications unit 810, in these examples, provides for communications with other data processing systems or devices. In these examples, communications unit 810 includes one or more network interface cards. Communications unit 810 may provide communications through the use of either or both physical and wireless communications links.

I/O interface(s) 812 allows for input and output of data with other devices that may be connected to device 800. For example, I/O interface(s) 812 may provide a connection to external device(s) 818 such as a keyboard, a keypad, a touch screen, and/or some other suitable input device. External device(s) 818 can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 808 via I/O interface(s) 812. I/O interface(s) 812 also connect to a display 820.

Display 820 provides a mechanism to display data to a user and may be, for example, a computer monitor.

Various features described herein may be implemented in hardware, software executed by a processor, firmware, or any combination thereof. If implemented in software (e.g., in the case of the methods described herein), the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

1. At least one non-transitory computer-readable storage medium including instructions that, when executed by a centralized Internet of Things (IoT) manager of an IoT system, cause the centralized manager to:
receive a machine learning (ML) model at a ML inference generation tool;
retrieve a hardware configuration of an edge system of the IoT system;
configure the ML model for the edge system based on the hardware configuration of the edge system to generate a ML model application; and
deploy the ML model application to the edge system.

2. The at least one computer-readable storage medium of claim 1, wherein the instructions further cause the centralized IoT manager to provide a run time environment in the ML model application that is associated with an execution hardware component of the hardware configuration.

3. The at least one computer-readable storage medium of claim 2, wherein the instructions further cause the centralized IoT manager to provide a second run time environment in the ML model application associated with a second execution hardware component of the hardware configuration.

1. The at least one computer-readable storage medium of claim 1, wherein the instructions further cause the centralized IoT manager to provide a run time environment in the ML model application that is associated with least one of a graphics processor unit (GPU), a tensor processing unit (TPU), a hardware accelerator, or a video processing unit (VPU).

5. The at least one computer-readable storage medium of claim 1, wherein the instructions further cause the centralized IoT manager to configure the ML model based on processor usage, memory usage, or combinations thereof.

6. The at least one computer-readable storage medium of claim 1, wherein the instructions further cause the centralized IoT manager to configure the ML model application for the edge system is further based on ML model metrics.

7. The at least one computer-readable storage medium of claim 6, wherein the instructions further cause the centralized IoT manager to evaluate the ML model to determine the ML model metrics.

8. The at least one computer-readable storage medium of claim 7, wherein the instructions further cause the centralized IoT manager to evaluate the ML model to determine floating point operations per second, a size of the ML model, or combinations thereof.

9. At least one non-transitory computer-readable storage medium including instructions that, when executed by a processor of an edge system of an Internet of Things (IoT) system, cause the processor of the edge system to:
receive, at a machine learning (ML) inference service, a request for an inference from a ML model application having a ML model;
load the ML model application into an inference engine in response to the request;
select a runtime environment from the ML model application to execute the ML model based on a hardware configuration of the edge system;
cause the ML model to be executed using the selected runtime environment to provide an inference result; and
provide the inference result at an output.

10. The at least one computer-readable storage medium of claim 9, wherein the instructions further cause the edge system to select the runtime environment associated with a first execution hardware component in response to a second execution hardware component being unavailable.

11. The at least one computer-readable storage medium of claim 9, wherein the instructions further cause the edge system to load the ML model application into an inference engine in response to a determination that the ML model application is unavailable in other inference engines.

12. The at least one computer-readable storage medium of claim 9, wherein the instructions further cause the edge system to map the ML model application to the inference engine.

13. The at least one computer-readable storage medium of claim 12, wherein the instructions further cause the edge system to direct a second request for an inference from the ML model application to the inference engine in response to a determination that the ML model application is mapped to the inference engine.

14. The at least one computer-readable storage medium of claim 12, wherein the instructions further cause the edge system to select a different runtime environment for execution of the second request.

15. The at least one computer-readable storage medium of claim 9, wherein the instructions further cause the edge system to receive an identifier associated with the ML model with the request.

16. The at least one computer-readable storage medium of claim 15, wherein the instructions further cause the edge system to receive a version of the ML model with the request.

17. A method, comprising:
receiving a machine learning (ML) model at a ML inference generation tool of a centralized Internet of Things (IoT) manager of an IoT system;
retrieving a hardware configuration of an edge system of the IoT system;
configuring the ML model for the edge system based on a hardware configuration of the edge system to generate a ML model application; and
deploying the ML model application to the edge system.

18. The method of claim 17, further comprising providing a run time environment in the ML model application that is associated with an execution hardware component of the hardware configuration.

19. The method of claim 18, further comprising providing a second run time environment in the ML model application associated with a second execution hardware component of the hardware configuration of the edge system.

20. The method of claim 18, further comprising providing a run time environment in the ML model application that is associated with at least one of a graphics processor unit (GPU), a tensor processing unit (TPU), a hardware accelerator, or a video processing unit (VPU).

21. The method of claim 17, further comprising configuring the ML model application for the edge system based on to processor usage, memory usage, or combinations thereof.

22. The method of claim 17, further comprising configuring the ML model application for the edge system is further based on ML model metrics.

23. The method of claim 22, further comprising evaluating the ML model to determine the ML model metrics.

24. The method of claim 23, further comprising evaluating the ML model to determine floating point operations per second, a size of the ML model, or combinations thereof.

25. An edge system of an Internet of Things system, the edge system comprising:
a memory configured to store a machine learning (ML) model application having a ML model a machine; and
a processor configured to cause a ML inference service to:
receive a request for an inference from a ML model application having a ML model;
load the ML model application from the memory into an inference engine in response to the request;
select a runtime environment from the ML model application to execute the ML model based on a hardware configuration of the edge system;
execute the ML model using the selected to provide an inference result; and
provide the inference result at an output.

26. The edge system of claim 25, further comprising a first execution hardware component, wherein the processor is further configured to cause the ML inference service to select the runtime environment associated with a first execution hardware component in response to a second execution hardware component being unavailable.

27. The edge system of claim 25, wherein the processor is further configured to cause the ML inference service to load the ML model application into an inference engine in response to a determination that the ML model application is unavailable in other inference engines.

28. The edge system of claim 25, wherein the processor is further configured to cause the ML inference service to map the ML model application to the inference engine.

29. The edge system of claim 28, wherein the processor is further configured to cause the ML inference service to direct a second request for an inference from the ML model application to the inference engine in response to a determination that the ML model application is mapped to the inference engine.

30. The edge system of claim 28, wherein the processor is further configured to cause the ML inference service to second a second runtime environment to execute the second request.

31. The edge system of claim 25, wherein the processor is further configured to receive an identifier associated with the ML model with the request.

32. The edge system of claim 31, wherein the processor is further configured to receive a version of the ML model with the request.

33. The at least one computer-readable storage medium of claim 1, wherein the instructions further cause the centralized IoT manager to provide a run time environment in the MI. model application that is associated with a graphics processor unit.

34. The at least one computer-readable storage medium of claim 1, wherein the instructions further cause the centralized IoT manager to provide a run time environment in the ML model application that is associated with a tensor processing unit.

35. The method of claim 18, further comprising providing a run time environment in the ML model application that is associated with a video processing unit.
